(19) United States
(12) Patent Application Publication
(10) Pub. No.: US 2017/0020108 A1
(43) Pub. Date: Jan. 26, 2017

(54) Cat comb

(71) Applicant: Angus Antoine Stevens, Toronto (CA)

(72) Inventor: Angus Antoine Stevens, Toronto (CA)

(21) Appl. No.: 14/805,437

(22) Filed: Jul. 21, 2015

(51) Int. Cl. A01K 13/00

(52) U.S. Cl. CPC A01K 13/002

(57) ABSTRACT

Pet grooming devices range from complex powered washing devices through combination cutting and combing devices to rotary axis brushes. A common them in all such devices is a device composed of a linear array of tines or teeth that help to remove clumps or mats in the fur of the pet. The cat comb described herein is composed solely of a flat handle from which a linear array of tines emanates; however, said tines alternate in length leading to the grooming benefit of gathering shed cat hair back up between the tines and allowing the tines to perform their other function of grooming pet hair through separation and removal of matting. Periodic removal of the shed hair mat from the comb is necessary.

### REFERENCE TO RELATED APPLICATIONS

No cross reference is made to other applications.

### STATEMENT REGARDING FEDERALLY SPONSORED RESEARCH OF DEVELOPMENT

No Federal Government support was received in the development of this Invention.

### SEQUENCE LISTING, TABLE, OR COMPUTER PROGRAM LISTING

No sequence listing, table, or computer program is attached or accompanies this Application.

### FIELD OF THE INVENTION

This Invention relates generally to pet grooming devices, and more particularly to a comb designed to maximize the removal of shed hair from cat fur.

### BACKGROUND OF THE INVENTION

Pet grooming devices include a plurality of secondary tools including washing devices, cutting devices, and vacuuming devices, yet the majority of them employ a head consisting of teeth or tines, which may be defined as largely parallel spaced projections emanating from a spine or handle and of girth dimension considerably less than their length. A spine running perpendicular to the length of said tines holds the proximal end of the tine rigid in order to run the tines through the coat of an animal in the action of grooming, satisfying the primary objective of aligning the hairs on the fur and removing matted tats of hair. A secondary objective is to remove hair that has already been shed and lies amongst the fur. Auxiliary handles may run perpendicular to said spine and teeth. Optionally, a more robust tine at either end of the linear array of tines may protect the delicate tines.

In this Invention called the cat comb, a spine suspending parallel and rigid tines is characterized by a binary alternation of the length of otherwise parallel tines of equal cross-sectional area. The delicate tines are protected at either end of the array with a more robust tine. Said linear array of tines alternating in length from short to long may be placed in collinear fashion with a second array of tines alternating in length yet more robust in cross-sectional area and with greater spacing to comb coarser fur or pre-comb heavily matted fur.

Through the provision of said objective of aligning hairs in the animal fur to remove matted tats, the Invention described in this Application can be used as a grooming tool. Through provision of said secondary objective of removing shed hair from with the fur, the Invention described in this invention can be used as a fur cleaning tool.

Patented devices for the grooming of pets include a variety of devices that all employ a linear array of tines, yet the concept of a binary alternation of tine length to not only align fur hair but to remove underlying shed hair is not found in any of the extant patents. Fung (U.S. Pat. No. 9,049,844, Jun. 9, 2015) describes a linear array of teeth equipped with microblades to cut hair at the junction of the teeth with the spine of the comb portion of the device. Weinstein (U.S. Pat. No. 9,038,228, May 26, 2015) describes a brush with two different kinds of tufts of bristle; however, the difference between the tufts involves bristle hair density and diameter, as opposed to length, and does not describe any linear arrays of tines. Perkins et al. (U.S. Pat. No. 9,027,511, May 12, 2015) describe a linear array of teeth as part of the device, but the teeth are equal in length. Kissel (U.S. Pat. No. 9,004,009, Apr. 14, 2015) presents a plurality of linear arrays of tines, said plurality of arrays running in a plurality of lines parallel to the cylindrical axis of a roll into which said linear arrays of tines are set. Kissel's brush rotates while grooming; however, all the tines are the same length. Porter et al. (U.S. Pat. No. 7,077,076, Jul. 18, 2006) describes a combination of comb and cutting blade in a grooming device; however all tines are equal in length.

### SUMMARY OF THE INVENTION

Accordingly, it is an objection of this invention to at least partially overcome some of the disadvantages of the prior art.

The Invention, a comb for grooming pets, in particular cats, is composed of a spine acting both as a handle and providing a mounting edge for a linear array or arrays of tines running largely perpendicular to the long axis of the spine and coplanar with its sides. With the linear array there is a binary alteration of length in the spines from short to long and back to short. If there are two collinear linear arrays in the comb, both arrays have binary alteration in tine length.

### BRIEF DESCRIPTION OF THE DRAWINGS

In the drawing, which illustrate embodiments of the invention:

FIG. 1 (a) shows a front view of the cat comb and (b) a detail showing differing length of comb teeth.;

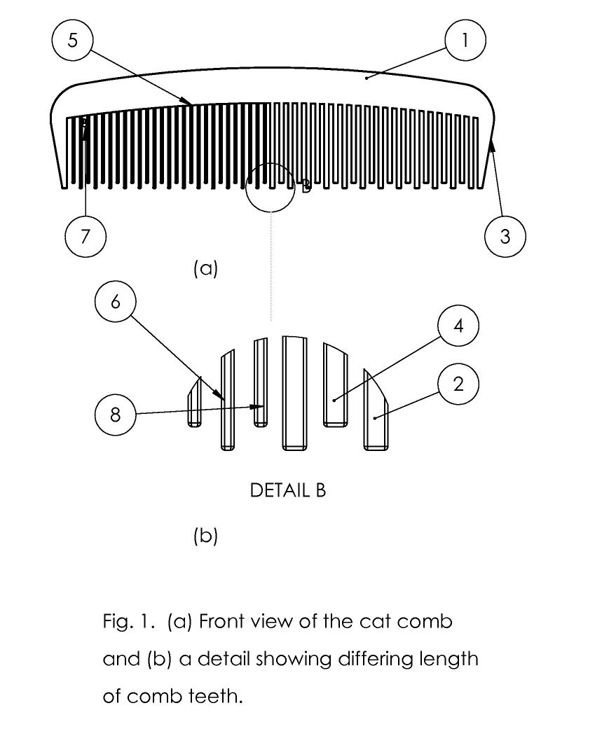

### DETAILED DESCRIPTION OF THE INVENTION

The Invention described in this Application is a novel pet grooming device for efficiently removing shed hair from the fur of a cat. A front lateral view of the cat comb shows a spine 1 supporting a linear array of parallel teeth 9. This array of teeth is bound on either end by a more robust protecting protrusion 3. A detailed view of the teeth 9 reveal a consistent binary alteration in the length of the teeth between long 6 and short 8 teeth. Midway along the array of teeth the thickness of the teeth increases, yet the alteration of teeth length between long 4 and short 2 continues.

In using the comb to groom the fur of a cat, said alteration in length allows for shed hair 7 laying close to the animal skin to be gathered up to the base of the teeth at the juncture of attachment of teeth to spine, while the distal ends of the teeth stay clear of clogging with cat hair.

1. A tool for grooming and animal, said tool comprising:
a. a flat handle longer than its height;
b. a plurality of parallel tines emanating in a linear array from one edge of said handle, wherein the tines are the same thickness of the edge of the flat handle and alternate in length from short to long back to short, maintaining an ability to comb the hair while gathering shed hair at the juncture of the tines with the flat handle;
c. two protecting tines of larger width appearing at either end of the linear array of tines.

2. One or two linear arrays of tines of alternating length, said arrays being collinear along the edge of the flat handle, the tines of each array being different in thickness and spacing to suit differing fur quality.

3. A largely two-dimensional form extruded to the minimum thickness necessary to ensure robustness of the handle and tines.
